(19) United States
(12) Patent Application Publication
(10) Pub. No.: US 2008/0037518 A1
(43) Pub. Date: Feb. 14, 2008

(54) METHOD AND APPARATUS FOR VOICE OVER INTERNET PROTOCOL CALL SIGNALING AND MEDIA TRACING

(76) Inventors: Parameswaran Kumarasamy, San Jose, CA (US); Soumya Kumar Kalahasti, Fremont, CA (US); Prasad Miriyala, Union City, CA (US); Michael Edric Tasker, Pleasanton, CA (US); Manjunath Sreedhara Bangalore, San Jose, CA (US)

Correspondence Address: SCHWEGMAN, LUNDBERG & WOESSNER, P.A., P.O. BOX 2938, MINNEAPOLIS, MN, 55402, US

(21) Appl. No.: 11/460,219

(22) Filed: Jul. 26, 2006

(51) Int. Cl. H04L 12/66

(52) U.S. Cl. 370/352

(57) ABSTRACT

Various embodiments provide methods and systems operable to receive a VoIP signaling packet, the VoIP signaling packet including information indicative of a request for trace information, to append trace information to the VoIP signaling packet; and to route the VoIP signaling packet with the trace information to a next network element on a path to a destination node. If an error condition is encountered, the VoIP signaling packet with the trace information is routed to a previous network element on a path to a source node.

### TECHNICAL FIELD

The disclosed subject matter relates to the field of network communications, and more particularly to voice over Internet Protocol (VoIP) communications.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2006 Cisco Systems, Inc. All Rights Reserved.

### BACKGROUND

Voice over Internet Protocol (VoIP) is being increasingly used by customers for local, long distance and international calls. There are many potential points of failure in a VoIP network, such as device failures, overloaded devices, network failures, etc. All these weaknesses in VoIP networks contribute to call failure or voice quality issues, such as no voice, one way voice, disturbed voice, etc. When users encounter such issues and report to VoIP service providers, there is no efficient way to trace the signaling and media path to a given destination. Thus, there is no efficient way to isolate the problematic device or subnetwork between the source and destination of the call. It would be beneficial to trace the signaling and the media path of a VoIP call from source to destination. The source is typically a VoIP operator/administrator and the VoIP destination is usually a destination user or the closest gateway where a problem was reported.

Thus, a method and apparatus for call signaling and media tracing in a voice over IP (VoIP) network is needed.

### BRIEF DESCRIPTION OF THE DRAWINGS

FIG. 1 illustrates a VoIP network environment in which various embodiments can operate.

FIG. 2 illustrates a VoIP call connection between a VoIP call originator and a VoIP call destination in a VoIP network environment in which various embodiments can operate.

FIG. 3 illustrates an example of the assertive model of various embodiments.

FIG. 4 illustrates an example of the assertive model of various embodiments in which a connection is broken.

FIG. 5 illustrates an example of the record on error model of various embodiments in which a VoIP connection is broken.

FIG. 6 illustrates an example of the various physical paths VoIP data can take to a VoIP call destination.

FIG. 7 illustrates an example of the assertive model of various embodiments in which physical network routing information is appended to a VoIP message.

FIG. 8 illustrates a network environment in which an example of a VoIP signaling connection and a VoIP media connection is shown.

FIGS. 9 and 10 are flow diagrams showing the basic processing logic of various example embodiments.

FIG. 11 is a flow diagram illustrating the processing performed for an embodiment of the assertive model where call trace routing can be performed for successful calls.

FIGS. 12 and 13 illustrate an example of a computer system on which processing for various embodiments can be implemented.

### DETAILED DESCRIPTION

In the following detailed description, reference is made to the accompanying drawings that form a part hereof, and in which are shown by way of illustration, specific embodiments in which the disclosed subject matter can be practiced. It is understood that other embodiments may be utilized and structural changes may be made without departing from the scope of the disclosed subject matter.

As described further below, according to various example embodiments of the disclosed subject matter described herein, there is provided a method and apparatus, including a VoIP call trace information generator, for call signaling and media tracing in a voice over IP (VoIP) network. As described below, the VoIP call trace information generator includes a message processor to receive a VoIP signaling or VoIP media packet, the VoIP signaling or VoIP media packet including information indicative of a request for trace information, to decode the information indicative of a request for trace information, and to append trace information to the VoIP signaling or media packet, and a message transfer engine to route the VoIP signaling or media packet with the trace information to a next network element on a path to a destination node.

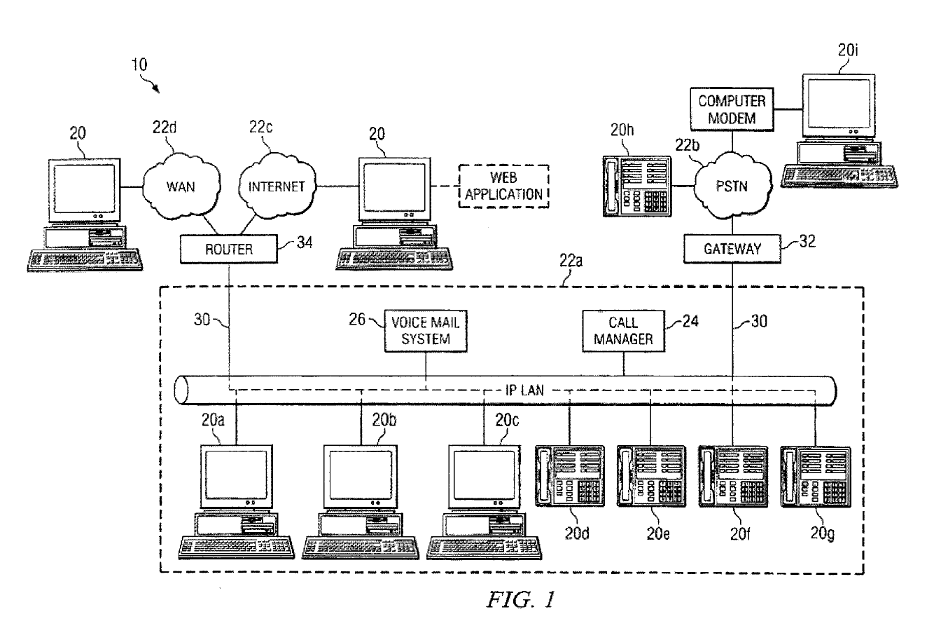

FIG. 1 illustrates an example of a communications system 10 for implementing a voice-over-Internet Protocol (VoIP) system. System 10 includes a plurality of endpoints 20 having the ability to establish communication sessions between each other, using one or more of communication networks 22a-22d. System 10 also includes one or more call managers 24 that cooperate with a voice mail system 26 to manage incoming calls and other communications for endpoints 20. In the illustrated embodiment, system 10 includes a local area network (LAN) 22a, a Public Switched Telephone Network (PSTN) 22b, a public network 22c, and a wide area network (WAN) 22d, which cooperate to provide communication services to the variety of types of 30 endpoints 20 within system 10. Specifically, LAN 22a couples multiple endpoints 20a-20g for the establishment of communication sessions between endpoints 20a-20g and other endpoints 20 distributed across multiple cities and geographic regions. Generally, LAN 22a provides for the communication of packets, cells, frames, or other portions of information (generally referred to as packets herein) between endpoints 20. Accordingly, LAN 22a may include any combination of network components, gatekeepers, call managers, routers, hubs, switches, gateways, endpoints, or other hardware, software, or embedded logic implementing any number of communication protocols that allow for the exchange of packets in communication system 30. In the illustrated embodiment, LAN 22a includes a plurality of segments 30 that couple endpoints 20a-20g with call manager 24, voice mail system 26, gateway 32, 15 router 34, and communication networks 22b-22d. Specifically, segments 30 couple endpoints 20a-20g with PSTN 22b, Internet 22c, and WAN 22d to allow communication with various devices located outside of LAN 22a. Because both audio and/or video telecommunication 20 signals may be communicated over LAN 22a, LAN 22a may eliminate the need, in certain embodiments, for a separate telephone network, such as a private branch exchange (PBX), to provide telecommunication services within a business or other organization.

Although the illustrated embodiment includes four communication networks 22a-22d, the configuration of networks 22a-22d are provided as merely one example configuration of a system 10 for establishing communication sessions between and among system components. The term “communication network” should be interpreted as generally including any network capable of transmitting audio and/or video telecommunication signals, data, and/or messages, including signals, data, or messages transmitted through text chat, instant messaging, and e-mail (referred to herein generally as media). Any one of networks 22a-22d may be implemented as a local area network (LAN), wide area network (WAN), global distributed network such as the Internet, Intranet, Extranet, or any other form of wireless or wireline communication network. It is generally recognized that system 10 may include any combination of networks and that system 10 may include fewer or more networks 22a-22d as is required by the number of endpoints 20 or the desired traffic across system 10.

In various embodiments, communication network 10 employs voice communication protocols that allow for the addressing or identification of endpoints, nodes, and/or call managers coupled to communication network 10. For example, LAN 22a may be an Internet Protocol (IP) network or any other type of network that allows each of the components coupled together by LAN 22a in communication system 10 to be identified using IP addresses. IP networks transmit data (including telecommunication data/signals) by placing the data in packets and sending the packets individually to the selected destination. This may be referred to as a packet network. Other types of packet networks include ATM, Frame Relay, Ethernet, SNA, and SONET networks, among others. Unlike a circuit-switched network (e.g., PSTN 22b), dedicated bandwidth is not required for the duration of a communication session over LAN 22a. Instead, each endpoint sends packets as they become available for transmission. In this manner, network 10 may support any form and/or combination of point-to-point, multicast, unicast, or other techniques for exchanging VoIP media packets among components in communication system 10. Any network components capable of exchanging audio, video, or other data using frames or packets, are included within the scope of the various embodiments described and claimed herein.

The technology that allows communication signals to be transmitted over an IP network may be referred to as Voice over IP (VoIP). In various embodiments, one or more of endpoints 20a-20g may include an IP telephony device. IP telephony devices have the capability of encapsulating a user's voice (or other inputs) into IP packets so that the voice can be transmitted over LAN 22a (as well as Internet 22c and WAN 22d, which may also be packet networks). IP telephony devices may include telephones, fax machines, computers running telephony software, and any other devices capable of performing telephony functions over an IP network.

Call manager 24 controls IP telephony devices within LAN 22a. Call manager 24 is an application that controls call processing, routing, telephony device features and options (such as call hold, call transfer and caller ID), device configuration, and other telephony functions and parameters within communications system 10. When a user wishes to place a call from one telephony device, such as endpoint 20d, to another telephony device, such as endpoint 20e, on LAN 22a, the calling device transmits signaling to call manager 24 indicating the desired function and destination. Call manager 24 then instructs endpoints 20d and 20e to establish a network connection between themselves over LAN 22a. Once endpoints 20d and 20e have established a connection, a codec (coder/decoder) converts the voice or other telecommunication signals generated by the users of endpoints 20d and 20e from analog signals into digital form. Endpoints 20d and 20e may implement the codec either in software or as special-purpose hardware. For example, for a voice communication sent from endpoint 20d to endpoint 20e, the codec in endpoint 20d digitizes the outgoing telecommunication signals. Endpoint 20d then encapsulates the digital telecommunication data within IP packets so that the data can be transmitted over LAN 22a. This encapsulation is typically performed by Real-Time Transport Protocol (RTP) running over UDP/EP (User Datagram Protocol/Internet Protocol). The encapsulation process is well-known in the art, and will not be described in further detail. The IP packets are then transported over LAN 22a via the IP protocol to endpoint 20e and other endpoints participating in the call. A codec in the receiving endpoint 20e then translates the IP packet data into analog voice signals for presentation to the user. This process is repeated each time that a call participant (or other source) generates telecommunication signals.

In addition to intra-LAN telephone calls, calls can also be placed to non-IP telephony devices, such as endpoint 20h, that are connected to PSTN 22b. PSTN 22b includes switching stations, central offices, mobile telephone switching offices, pager switching offices, remote terminals, and other related telecommunications equipment that are located throughout the world. Calls placed to endpoint 20h are made through VoIP-to-PSTN gateway 32. Gateway 32 converts analog or digital circuit-switched data transmitted by PSTN 22b or a PBX) to packet data transmitted by LAN 22a, and vice-versa. Gateway 32 also translates between the VoIP call control system protocol and the Signaling System 7 (SS7) or other protocols used in PSTN 22b. For example, when making a call to a PSTN endpoint 20h from an IP endpoint 20d, the telecommunication signal generated by the user of endpoint 20d is digitized and encapsulated, as described above. The packets are then transmitted over LAN 22a to gateway 32. Gateway 32 converts the data in the packets to the format (either digital or analog) used by PSTN 22b. The voice signals are then sent to the PSTN endpoint 20h over PSTN 22b. This process is continued between LAN 22a and PSTN 22b through gateway 32 until the call is complete. Calls also may be made between IP telephony devices, such as endpoint 20d, and other IP telephony devices located on Internet 22c or across WAN 22d. Again, the telecommunication data is digitized and encapsulated into IP packets at the telephony device. However, unlike communications with devices on PSTN 22b, a gateway is not needed to convert the IP packets to another format. A router 34 (or other similar device such as a hub or bridge) directs the packets to the IP address of the receiving IP telephony device.

In an example scenario, a first end user may be associated with a first endpoint 20d, which comprises a telephony device, and a second end user may be associated with a second endpoint 20e, which comprises another telephony device. To initiate a communication session, the first end user may use first endpoint 20d to call the second end user at second endpoint 20e. Where the second end user is participating in a previous call or is otherwise unavailable to take the incoming call from the first end user, call manager 24 may intervene by intercepting the call and forwarding the call to voice mail system 26.

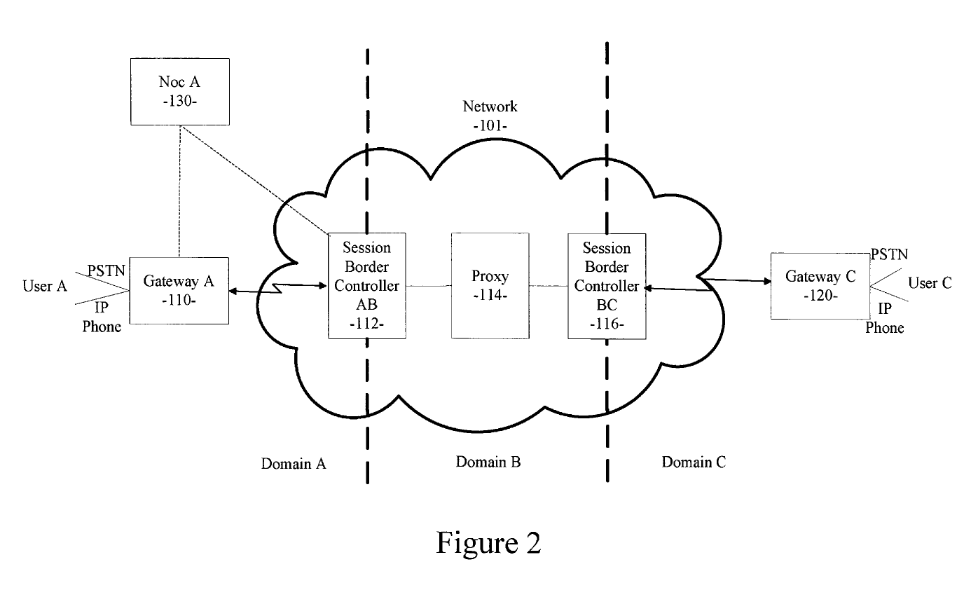

FIG. 2 illustrates a VoIP connection between a user A and a user C via a network 101. In general, user A is connected to gateway A 110 via a PSTN telephone or an IP phone as described above in connection with FIG. 1. Gateway A 110 receives telecommunication data from user A, which is digitized and encapsulated into IP packets at the telephony device. The gateway A 110 transfers this telecommunication data into network 101. The telecommunication data can take a variety of paths through network 101. In one example, Gateway A 110 transfers the telecommunication data to a session border controller AB 112. As shown in the example of FIG. 2, network 101 is partitioned into a plurality of domains. Such network partitioning is common in conventional wide-area networks. A well known session border controller component such as session border controller AB 112 is provided in network 101 to transition data between two different domains within network 101. In this example, session border controller AB 112 serves as the transition component between Domain A and Domain B illustrated in FIG. 2. The session border controller AB 112, in this example, receives telecommunication data from Gateway A 110 and forwards the data to a proxy 114 in domain B. It will be apparent to one of ordinary skill in the art that session border controller AB 112 could also forward the telecommunication data to other network components such as network routers, hubs, switches, proxies, and the like. In the example of FIG. 2, the proxy 114 is also a well known VoIP network component. The proxy 114 can then forward the telecommunication data to another session border controller BC 116. Session border controller BC 116 serves as the transition component between Domain B and Domain C illustrated in FIG. 2. The session border controller BC 116, in this example, receives telecommunication data from proxy 114 and forwards the data to Gateway C 120. Gateway C 120 then routes the telecommunication data to a VoIP telephony device operated by user C. The telephony device operated by user C (e.g. a PSTN telephone or an IP phone) can thereby be set up to receive a call from user A. In this manner, a VoIP connection between user A and user C can be signaled through network 101. As well known in a conventional VoIP network, once the VoIP call is set up, media data corresponding to the content of the call (e.g. audio and/or video telecommunication signals, data, and/or messages, including signals, data, or messages transmitted through text chat, instant messaging, and e-mail) can be transferred between user A and user C via a different network path than the path taken by the signaling data as described above.

As well known to those of ordinary skill in the art, networks typically have a network operations center (NOC) that monitors and manages the operation of a particular network and/or a network domain. In the example of FIG. 2, network operations center (NOC) A 130 serves as the network management center for domain A of network 101. NOC A 130 can monitor the flow of network data packets between network components within domain A at the physical network layer; however, NOC A 130 cannot, in conventional networks, monitor the integrity of data transfers in a VoIP call connection between user A and user C. Because VoIP signaling data and VoIP media data can take different paths through multiple domains of a wide-area network, current network operations centers cannot determine with specificity the point of failure in network 101 when an attempted VoIP connection between user A and user C fails. This is because current VoIP networks do not have the capability for call signaling and media tracing in a VoIP network. As will be described in more detail below, the various embodiments described and claimed herein provide this capability.

Referring still to FIG. 2, an example of a VoIP call connection between User A and User C was described above. However, in some cases, the VoIP call connection cannot be established; because a network element in a path between user A and user C is unable to complete the transfer of a telecommunications signaling packet to a next network element in the path to the destination node (e.g. user C in this example). For example, proxy 114 may attempt to forward telecommunication data as part of the VoIP signaling process to session border controller BC 116. However, session border controller BC 116 may be unresponsive or unable to complete the transfer of the telecommunication data from proxy 114. In this case, proxy 114 must report an error condition back to session border controller AB 112, which reports an error back to gateway A 110, which reports the error to the VoIP telephony device of user A. Unfortunately, in a conventional network, gateway A 110 cannot determine from the error message received from session border controller AB 112 where or why the error occurred at some point downstream in network 101. All that gateway A 110 can determine from the error message is that some network component in network 101 was unable to complete the transfer of a telecommunications signaling packet to a next network element in the path to the destination node. Because gateway A 110 cannot determine the precise point of failure in the network 101, it is very difficult for gateway A 110 to correct the problem. In some cases, gateway A 110 can notify NOC A 130 of the problematic VoIP connection as indicated by the dashed line shown in FIG. 2 between gateway A 110 and NOC A 130. NOC A 130 can re-try the VoIP connection by sending test VoIP signaling packets to session border controller AB 112, as indicated by the dashed line shown in FIG. 2 between NOC A 130 and session border controller AB 112. Alternatively, NOC A 130 can re-try the VoIP connection by sending test VoIP signaling packets to gateway A 110, which forwards the test packets to session border controller AB 112, as indicated by the dashed lines shown in FIG. 2 between NOC A 130, gateway A 110, and session border controller AB 112. It will be understood by those of ordinary skill in the art that NOC A 130 needs to authenticate itself, using well known techniques, to the session border controller AB 112 and/or the gateway A 110 prior to initiating a test of a VoIP connection. However, these VoIP test signaling packets sent into network 101 by NOC A 130 can suffer the same fate as the signaling packets sent earlier by gateway A 110. That is, the session border controller BC 116 may be unresponsive or unable to complete the transfer of the test data from proxy 114. In this case, proxy 114 must again report an error condition back to session border controller AB 112, which reports an error back to NOC A 130. Again, all that NOC A 130 can determine from the error message is that some network component in network 101 was unable to complete the transfer of a telecommunications signaling packet to a next network element in the path to the destination node. Because NOC A 130 cannot determine the precise point of failure in the network 101, it is also very difficult for NOC A 130 to correct the problem.

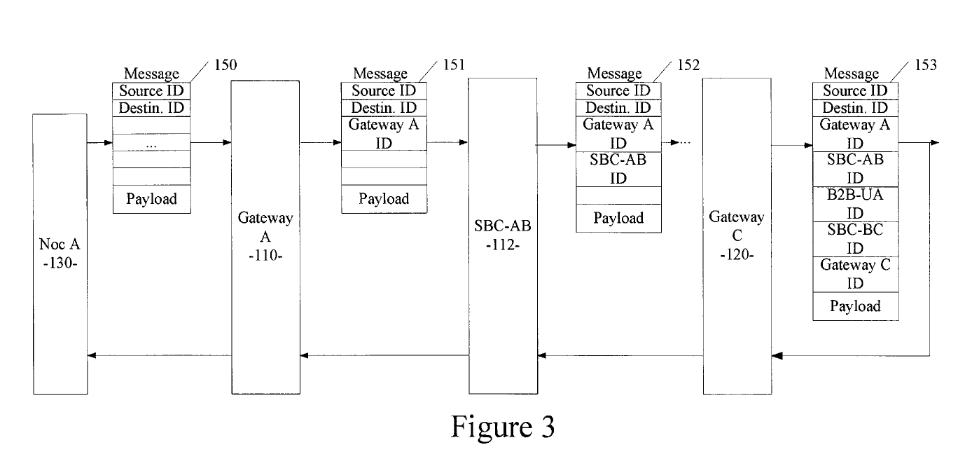

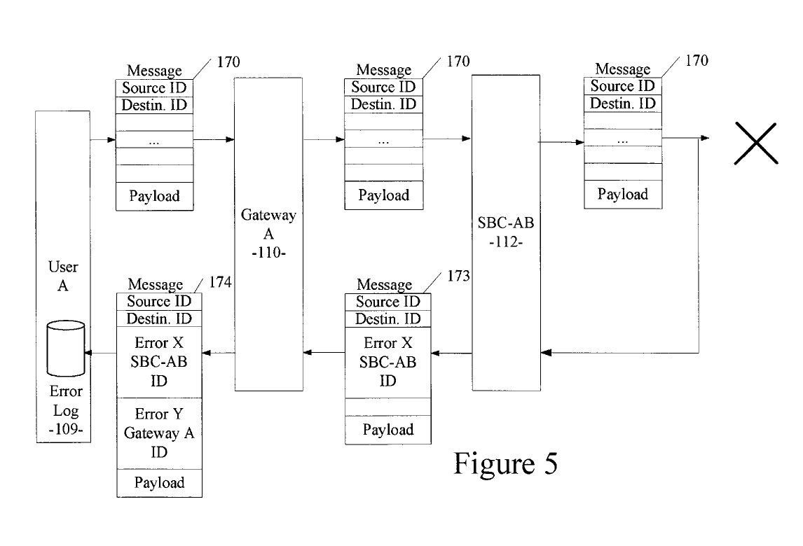

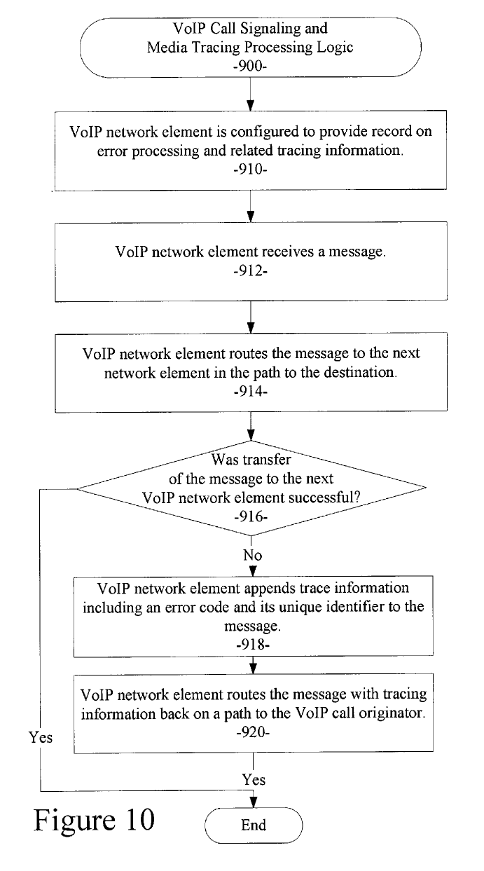

Various embodiments described and claimed herein solve this problem by providing a VoIP call trace function and a VoIP call trace information generator that enables a network component to determine the precise point of failure in network 101 during a VoIP call connection. Two alternative solutions will be described below. A first solution, denoted the assertive model, appends tracing information, including network device identifiers to each telecommunications signaling packet as the packet is routed from a VoIP call originator (e.g. user A) to a VoIP call destination (e.g. user C). The assertive model is shown and described below in connection with FIGS. 3-4, and 9. A second alternative solution described herein, denoted the record on error model, appends error and tracing information, including error codes and network device identifiers to each telecommunications signaling packet only when an error is encountered in the transfer of a telecommunications signaling packet to a next network element in the path to the destination node. The record on error model is shown and described below in connection with FIGS. 5 and 10.

Referring now to FIG. 3, an example embodiment of the assertive model is shown. In this example, NOC A 130 attempts to pinpoint the source of a network problem by sending a test signaling packet (e.g. message 150) to gateway A 110. This test data 150 is similar to a standard telecommunications signaling packet that would be sent for a standard VoIP connection, except the message 150 includes a special code that activates trace information functionality in each network element that processes the message 150. This special code can be a bit pattern in the header of the message or other form of a unique coding. Alternatively, a VoIP call trace mode can be configured in each network element in network 101 through an independent process. The trace mode activates the trace information functionality, a VoIP call trace information generator, in each network element as described herein. Upon receipt of the test message 150, the network element (e.g. gateway A 110) determines the test message 150 (or a previously configured trace mode) has activated trace information functionality in the network element. This trace information functionality can be installed in each network element as a software or firmware download or as a pre-configured hardware component of the network element. As part of this trace information functionality, the network element appends VoIP trace information to the test message 150, the trace information including a network device identifier of the network element prior to routing the test packet to the next network element on the path from a VoIP call originator (e.g. NOC A 130 or user A) to a VoIP call destination (e.g. user C). Thus, as shown in FIG. 3, message 150 has been modified by gateway A 110 to create message 151, which includes the trace information (e.g. a gateway A identifier or ID) provided by gateway A 110. Similarly, the next network element, session border controller AB 112, upon receipt of the test message 151 from the prior network element (e.g. gateway A 110) determines the test message 151 (or a previously configured trace mode) has activated trace information functionality in the network element. As part of this trace information functionality, the network element (e.g. session border controller AB 112) appends VoIP trace information to the test message 151, the trace information including a network device identifier of the network element prior to routing the test packet to the next network element on the path from the VoIP call originator (e.g. NOC A 130 or user A) to the VoIP call destination (e.g. user C). Thus, as shown in FIG. 3, message 151 has been modified by session border controller AB 112 to create message 152, which includes new trace information (e.g. a session border controller AB 112 identifier or ID) provided by session border controller AB 112. At this point in the progression of the test VoIP signaling packet on the path from the VoIP call originator (e.g. NOC A 130 or user A) to the VoIP call destination (e.g. user C), message 152 includes trace information that includes an identifier of each network element that has so far processed the message. As shown in FIG. 3, this process can continue for each network element on the path from the VoIP call originator (e.g. NOC A 130 or user A) to the VoIP call destination (e.g. user C). If the test VoIP connection is successful, the final VoIP network element in the path (e.g. Gateway C 120) will receive the test message. Gateway C 120 can then append its own VoIP trace information to the test message 152, to produce message 153. As shown in the example of FIG. 3, message 153 includes trace information from each network element in the path from the VoIP call originator (e.g. NOC A 130 or user A) to the VoIP call destination (e.g. user C). Gateway C 120 can then return the test message with the trace information to the VoIP test call originator (e.g. NOC A 130 or user A). In this manner, the trace information in message 153 can be used by the VoIP test call originator to trace the path of the VoIP call through network 101 from the VoIP call originator (e.g. NOC A 130 or user A) to the VoIP call destination (e.g. user C).

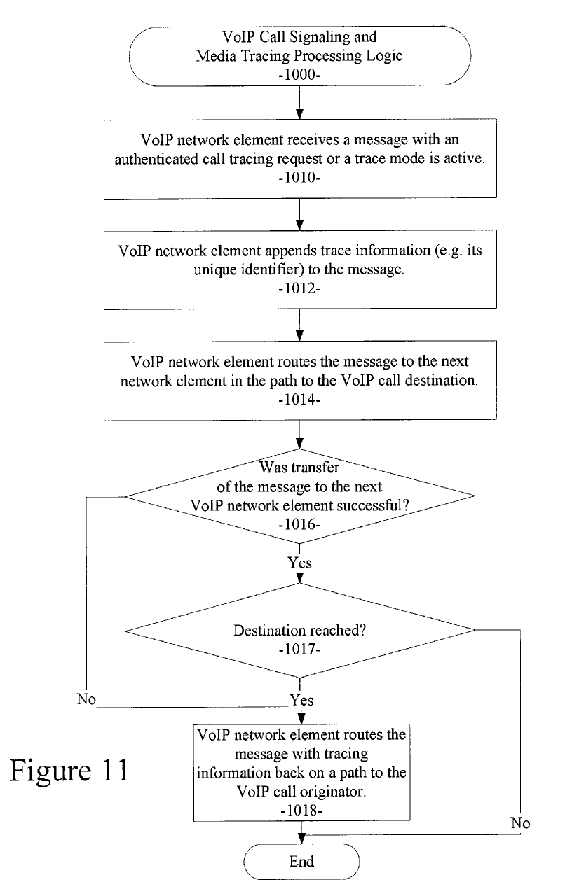

As illustrated in FIG. 3, various embodiments can be used for VoIP call trace routing for successful calls (i.e. those that reach the destination) as well as for calls that fail to make a connection to a destination. FIG. 11, described below, illustrates the processing logic for handling trace routing of successful calls.

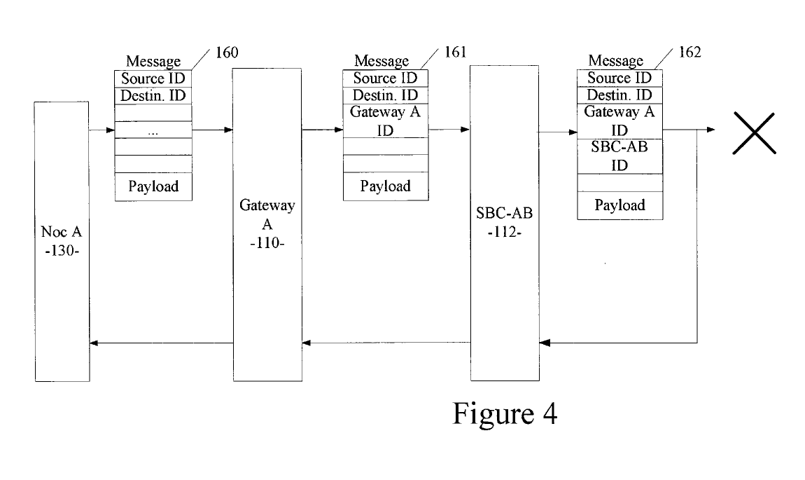

Referring now to FIG. 4, another example of the assertive model of an example embodiment is shown. In this example, NOC A 130 (e.g. the VoIP test call originator) attempts to pinpoint the source of a network problem by sending a test signaling packet (e.g. message 160) to a VoIP call destination (e.g. user C) via gateway A 110. As described above, upon receipt of the test message 160, the network element (e.g. gateway A 110) determines the test message 160 (or a previously configured trace mode) has activated trace information functionality in the network element. As part of this trace information functionality, the network element, using a message processor, appends VoIP trace information to the test message 160, the trace information including a network device identifier of the network element prior to routing the test packet to the next network element on the path from the VoIP call originator to the VoIP call destination using a message routing engine. Thus, as shown in FIG. 4, message 160 has been modified by a message processor of gateway A 110 to create message 161, which includes the trace information (e.g. a gateway A identifier or ID) provided by gateway A 110. Similarly, the next network element, session border controller AB 112, upon receipt of the test message 161 from the prior network element (e.g. gateway A 110), determines the test message 161 (or a previously configured trace mode) has activated trace information functionality in the network element. As part of this trace information functionality, the network element (e.g. session border controller AB 112) appends VoIP trace information to the test message 161, the trace information including a network device identifier of the network element prior to routing the test packet to the next network element on the path from the VoIP call originator to the VoIP call destination. Thus, as shown in FIG. 4, message 161 has been modified by session border controller AB 112 to create message 162, which includes new trace information (e.g. a session border controller AB 112 identifier or ID) provided by session border controller AB 112. At this point in the progression of the test VoIP signaling packet on the path from the VoIP call originator (e.g. NOC A 130 or user A) to the VoIP call destination (e.g. user C), message 162 includes trace information that includes an identifier of each network element that has so far processed the message. However, in the example shown in FIG. 4, we assume the network element (e.g. session border controller AB 112) attempts to forward the test message 162 to the next network element in the path to the destination; but, the next network element is unresponsive or unable to complete the transfer of the test data from session border controller AB 112 as indicated by the X shown in FIG. 4. In this case, upon the unsuccessful data transfer error condition, session border controller AB 112 routes the message 162 with the trace information on a path back to the VoIP call originator (e.g. NOC A 130 or user A) via the other network elements in the path (e.g. gateway A 110). In this manner, the trace information in message 162 can be used by the VoIP test call originator to trace the path of the VoIP call through network 101 from the VoIP call originator (e.g. NOC A 130 or user A) to the point of failure (e.g. a network element fed by session border controller AB 112). Thus, the VoIP call tracing information provided by the assertive model of various embodiments is effective for identifying the problematic network element and thus effective in suggesting solutions to correct failures in VoIP call connections.

Referring now to FIG. 5, an example of the record on error model of an example embodiment is shown. In this example, User A is a VoIP call originator. As provided in conventional network systems, the processing system being used by user A includes a storage area 109 for logging errors and other information for user A that may result from a VoIP call session. In the example illustrated in FIG. 5, user A is attempting to set up a call with user C (the VoIP call destination), as shown in prior examples described above. In this case, each network element in network 101 has been pre-configured in a “record on error” mode through an independent process. The “record on error” mode activates the error/trace information functionality, a VoIP call trace information generator, in each network element as described below. This error/trace information functionality can be installed in each network element as a software or firmware download or as a pre-configured hardware component of the network element. As part of this error/trace information functionality, the network element appends VoIP trace information to a VoIP telecommunications signaling packet (e.g. a message 170), only if the transfer of the message 170 to the VoIP call destination is not successful. The error/trace information includes an error code and a network device identifier of the network element prior to routing the message with the error/trace information to the previous network element on the path back to the VoIP call originator (e.g. user A).

Referring still to FIG. 5, the VoIP call originator (e.g. user A) initiates a VoIP call connection by sending a VoIP signaling message 170 to the next network element on the path to the VoIP call destination (e.g. user C). In this case, the next network element is gateway A 110. Gateway A 110 receives the message 170 and routes the message 170 to the next network element on the path to the VoIP call destination (e.g. user C). In this case, the next network element is session border controller AB 112. Note that in the example of the “record on error” modes illustrated in FIG. 5, the message 170 is not modified as the message 170 is routed to the next network element as long as the message transfer to the next network element is successful. In the example shown in FIG. 5, the transfer of message 170 to session border controller AB 112 is successful and thus message 170 is not modified as received by session border controller AB 112. However, in the example shown in FIG. 5, the transfer of message 170 from session border controller AB 112 to the next network element on the path to the VoIP call destination is unsuccessful. In this case, the record on error functionality in session border controller AB 112 is executed. The record on error functionality of various embodiments appends error/trace information to the message 170 when an error condition is encountered. This error/trace information can include an error code and/or an identifier of the network element that is processing the message. The modified message is then routed back to the previous network element on a path back to the VoIP call originator. Thus, as shown in FIG. 5, the transfer of message 170 from session border controller AB 112 to the next network element in the path to the VoIP call destination is unsuccessful. In this case, the message processor of session border controller AB 112 appends error/trace information to message 170 to create message 173. This error/trace information can include an error code and/or the identifier (ID) of session border controller AB 112. A message routing engine of session border controller AB 112 then routes the modified message 173 back to previous network element gateway A 110. Given the error condition, error/trace functionality in gateway A 110 is executed. In a manner similar to session border controller AB 112, gateway A 110 appends its own error/trace information to message 173 to create message 174. This error/trace information can include an error code and/or the identifier (ID) of gateway A 110. Given that gateway A 110 is the first VoIP network element on the path in this example, gateway A 110 then routes the modified message 174 to an error log 109 provided on a data storage device accessible to user A. Having stored the error/trace information in error log 109, user A and/or a network administrator can access this information and determine the specific network element in network 101 that failed to forward the VoIP signaling packet towards the VoIP call destination. Thus, two alternative solutions (i.e. the assertive model and the record on error model) are described in various embodiments for providing a VoIP call trace function that enables a network component to determine the precise point of failure in network 101 during a VoIP call connection.

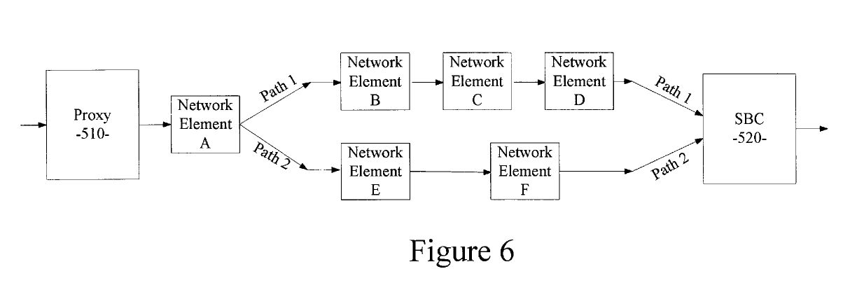

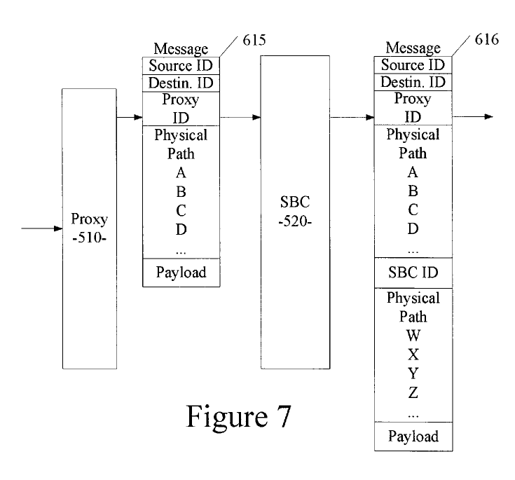

Another variation to either the assertive model or the record on error model is shown in FIGS. 6 and 7. As FIG. 6 illustrates, a particular VoIP telecommunications signaling packet can take any of a variety of paths between VoIP network elements. For example, a proxy component 510 can send a VoIP signaling packet to a network element A, which can then route the signaling packet via path 1 through network elements B, C, and D. Alternatively, network element A can route the signaling packet via path 2 through network elements E and F. The particular routing chosen at a given moment in time depends on the traffic load, the types of traffic, and the condition of the various involved network elements. Using conventional network functionality, proxy 510 can query the network to determine the physical path that the signaling packet will take between proxy 510 and session border controller (SBC) 520 prior to sending the signaling packet on to session border controller (SBC) 520. For example, proxy 510 can query the network for a physical routing prior to sending the signaling packet to network element A. The network may respond with a physical routing indicating, for example, that the signaling packet will be routed on path 1 through network elements A, B, C, and D on its way to VoIP network element SBC 520. In various alternative embodiments, this physical network routing information can also be included in the trace information appended to the signaling packet by proxy 510 prior to forwarding the signaling packet to the next VoIP network element (e.g. SBC 520). FIG. 7 illustrates this augmentation of the trace information in an example of the assertive model of various embodiments.

Referring to FIG. 7, as described above, proxy 510 has queried the network for a physical routing prior to sending a signaling packet to network element A. In this example, the network has responded with a physical routing indicating, for example, that the signaling packet will be routed on path 1 through network elements A, B, C, and D. Proxy 510 has appended trace information, including the physical routing information, to the signaling packet (i.e. message 615) along with an identifier of proxy 510. The message 615 with the trace information is then sent to the next VoIP network element (in this example, SBC 520). Using the same process, SBC 520 can query the network for a physical routing prior to sending the signaling packet 615 to the next VoIP network element on the path to the VoIP call destination. As shown by example in FIG. 7, SBC 520 has appended additional trace information, including physical routing information and an identifier of SBC 520, to message 615 thereby producing message 616, which is sent on to the next VoIP network element.

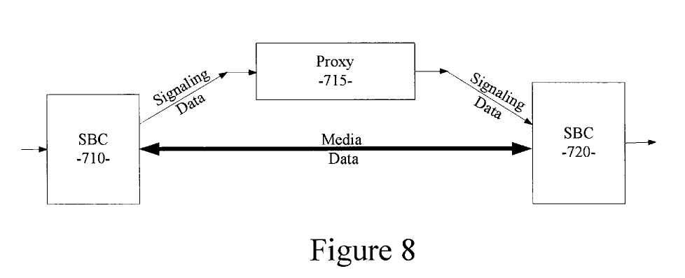

FIG. 8 illustrates the distinction between the routing of signaling data associated with a VoIP call connection and the routing of media data associated with the VoIP call connection. As well known, a typical VoIP call includes media content such as, audio and/or video telecommunication signals, data, and/or messages, including signals, data, or messages transmitted through text chat, instant messaging, e-mail, and the like. In a conventional VoIP call, the routing of signaling data can take a different path than the routing of media data associated with the VoIP call connection. In many cases, the media data requires a higher bandwidth connection than the signaling data. However, the various embodiments described herein are useable for any kind of data being sent between a VoIP call originator and a VoIP call destination as part of a VoIP call. Thus, the assertive model or the record on error model for providing VoIP call tracing information can be used for both the VoIP signaling packets and the VoIP media packets associated with a VoIP call. In this manner, the various embodiments described and claimed herein provide a VoIP call trace function that enables a network component to determine the precise point of failure in a VoIP network during a VoIP call connection, whether the failure happens in the transfer of signaling data or in the transfer of media data. Further, various embodiments can be used for VoIP call trace routing for successful calls as well. In another embodiment, when a media trace call is made and a call packet arrives at each network device, each network device adds its identification information to the call packet, and also includes the network device's media reservation status (e.g. RSVP status) to the call packet. In this manner, a network operations center can analyze the call packet information to determine potential problems with the transfer of media data corresponding to the VoIP call.

In another embodiment, when the signaling and media trace requests are sent to network devices, each network device can announce its reachability via a media path. In this way, the network operator does not need to interpret/read the trace information manually. Instead, the network operator can request each network device to send its identifier back to the operator. This will help to quickly isolate the specific failed device/network so that troubleshooting can be started quickly on the problematic system.

Various embodiments can be implemented with different VoIP protocols. An example of an embodiment implemented with a SIP protocol is provided below. It will be apparent to those of ordinary skill in the art that other embodiments can be implemented with other VoIP protocols (e.g. H.323).

In an embodiment implemented with conventional Session Initiation Protocol (SIP), VoIP call trace routing can be implemented by adding a new optional field to the conventional SIP signaling packet. The new field of the VoIP signaling packet can include information indicative of a request for trace information. The new field can be called, for example, Signaling-Trace-Route. In response to a request for call trace routing, each network device adds its own identifier information, such as IP address or device name identifier, along with a domain name. Note that some network devices may not include their IP address, for example, for address hiding purposes. In this case, a device/hostname could be used instead. An example of a SIP signaling packet in one embodiment is provided below.

INVITE sip: 9497778888@115.6.39.10 SIP/2.0.

From: sip: 9498889999@15.6.39.10; tag=1c23623

To: sip: 9497778888@15.6.39.10

Call-ID: call-973574142-2@15.5.27.209

Cseq: 1 INVITE

Signaling-Trace-Route: CME1@cisco.com

When the example SIP signaling packet traverses a network device, for example, a network device identified as IPIP-GW2, an embodiment updates the SIP signaling packet as follows:

INVITE sip: 9497778888@15.6.39.10 SIP/2.0.

From: sip: 9498889999@15.6.39.10; tag=1c23623

To: sip: 9497778888@15.6.39.10

Call-ID: call-973574142-2@15.5.27.209

Cseq: 1 INVITE

Signaling-Trace-Route: CME1@cisco.com; IPIP-GW2@att.com

As the example SIP signaling packet continues to traverse other network devices, for example, network devices identified as CSPS2 and CME-5, an embodiment updates the SIP signaling packet as follows:

INVITE sip: 9497778888@15.6.39.10 SIP/2.0.

From: sip: 9498889999@15.6.39.10; tag=1c23623

To: sip: 9497778888@15.6.39.10

Call-ID: call-973574142-2@15.5.27.209

Cseq: 1 INVITE

Signaling-Trace-Route:CME1@cisco.com;IPIP-GW2@att.com; CSPS2@sbc.com;CME-5@sbc.com

If this final device is a terminating gateway, the SIP signaling packet with the trace information will be sent back to the originating network device thereby providing VoIP call signaling trace routing information.

Similarly, an embodiment for VoIP media trace routing can be implemented with conventional Session Initiation Protocol (SIP). In this case, VoIP media trace routing can be implemented by adding a new optional field to the conventional SIP media packet. The new field can be called, for example, Media-Trace-Route. In response to a request for media trace routing, each network device adds its own identifier information, such as IP address or device name identifier, along with a domain name. Note that some network devices may not include their IP address, for example, for address hiding purposes. In this case, a device/hostname could be used instead. An example of a SIP media packet in one embodiment is provided below.

INVITE sip: 9497778888@15.6.39.10 SIP/2.0.

From: sip: 9498889999@15.6.39.10; tag=1c23623

To: sip: 9497778888@15.6.39.10

Call-ID: call-973574142-2@15.5.27.209

Cseq: 1 INVITE

Media-Trace-Route: User-A@CME1@cisco.com

When the example SIP media packet traverses a network device, for example, a network device identified as IPIP-GW2, an embodiment updates the SIP media packet as follows:

INVITE sip: 9497778888@15.6.39.10 SIP/2.0.

From: sip: 9498889999@15.6.39.10; tag=1c23623

To: sip: 9497778888@15.6.39.10

Call-ID: call-973574142-2@15.5.27.209

Cseq: 1 INVITE

Media-Trace-Route:User-A@CME1.cisco.com;MTP_{—}1@IPIP-GW2.att.com

As the example SIP media packet continues to traverse other network devices, for example, network devices identified as CSPS2 and CME-5, an embodiment updates the SIP media packet as follows:

INVITE sip: 9497778888@15.6.39.10 SIP/2.0.

From: sip: 9498889999@15.6.39.10; tag=1c23623

To: sip: 9497778888@15.6.39.10

Call-ID: call-973574142-2@15.5.27.209

Cseq: 1 INVITE

Media-Trace-Route:User-A@CME1@cisco.com;MTP_{—}1@IPIP-GW2.att.com; MTP_{—}2@CSPS2.sbc.com;MTP_{—}3@CME-5.sbc.com

If this final device is a terminating gateway, the SIP media packet with the trace information will be sent back to the originating network device thereby providing VoIP media trace routing information.

When multiple media types are involved, such as audio and video, media packets corresponding to each media type can take different routings through the network. These routings for each media type can be traced using the techniques taught herein. For example, in a teleconference scenario, video data may traverse through a media switch, but the corresponding audio may traverse through an audio mixer. In any case, the various embodiments taught herein can be used to trace the path of each type of media data through a network.

Though an example using a SIP protocol implementation is described above, other embodiments using other VoIP protocols, such as H.323, can be implemented in a similar manner using the techniques taught herein.

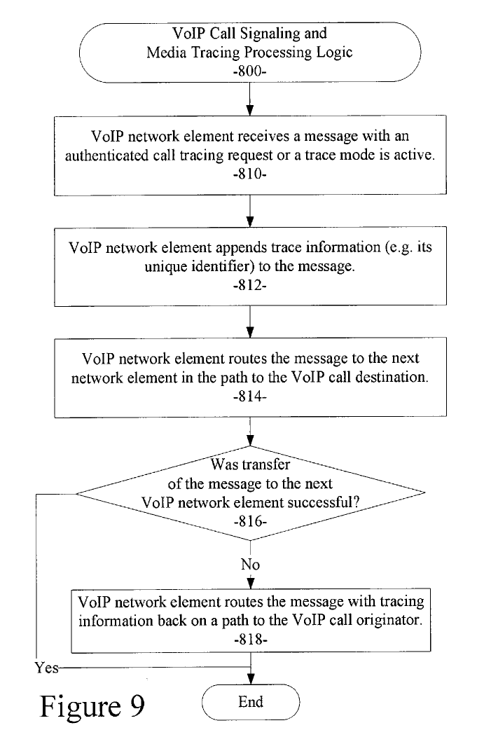

Referring now to FIGS. 9-11, processing flow diagrams illustrate the processing performed for various embodiments. FIG. 9 illustrates the processing performed for an embodiment of the assertive model. FIG. 10 illustrates the processing performed for an embodiment of the record on error model. FIG. 11 illustrates the processing performed for an embodiment of the assertive model where call trace routing can be performed for successful calls as well.

Referring to FIG. 9, processing performed for an embodiment of the assertive model is illustrated. Note that the example of the processing in various embodiments can be used for signaling and/or media data. In processing block 810, a VoIP network element receives a message with an authenticated call tracing request. Alternatively, the VoIP network element can receive a VoIP message while in a preconfigured trace mode. In either case, trace functionality is activated in the VoIP network element. In processing block 812, the VoIP network element appends trace information (e.g. its unique identifier) to the message. The VoIP network element then routes the message to the next network element on the path to the VoIP call destination (processing block 814). If the transfer of the message to the next VoIP network element is successful (decision block 816), processing for the VoIP network trace functionality terminates. However, if the transfer of the message to the next VoIP network element is not successful (decision block 816), the VoIP network element routes the message with tracing information back on a path to the VoIP call originator (processing block 818). Processing for the VoIP network trace functionality terminates at the End bubble shown in FIG. 9.

Referring to FIG. 10, processing performed for an embodiment of the record on error model is illustrated. Note that the example of the processing in various embodiments can be used for signaling and/or media data. In processing block 910, a VoIP network element is configured to provide record on error processing and related tracing information. Alternatively, the VoIP network element can receive a VoIP message with an authenticated request for record on error processing. In either case, trace functionality is activated in the VoIP network element. In processing block 912, the VoIP network element receives a message. The VoIP network element then routes the message to the next network element on the path to the VoIP call destination (processing block 914). If the transfer of the message to the next VoIP network element is successful (decision block 916), processing for the VoIP network trace functionality terminates. However, if the transfer of the message to the next VoIP network element is not successful (decision block 916), the VoIP network element appends trace information including an error code and its unique identifier to the message (processing block 918). The VoIP network element routes the message with tracing information back on a path to the VoIP call originator (processing block 920). Processing for the VoIP network trace functionality terminates at the End bubble shown in FIG. 10.

Referring to FIG. 11, processing performed for an embodiment of the assertive model where call trace routing can be performed for successful calls is illustrated. Note that the example of the processing in various embodiments can be used for signaling and/or media data. In processing block 1010, a VoIP network element receives a message with an authenticated call tracing request. Alternatively, the VoIP network element can receive a VoIP message while in a preconfigured trace mode. In either case, trace functionality is activated in the VoIP network element. In processing block 1012, the VoIP network element appends trace information (e.g. its unique identifier) to the message. The VoIP network element then routes the message to the next network element on the path to the VoIP call destination (processing block 1014). If the transfer of the message to the next VoIP network element is successful (decision block 1016), processing for the VoIP network trace functionality continues at decision block 1017. If the destination has not been reached (decision block 1017), processing for the VoIP network element terminates. However, if the transfer of the message to the next VoIP network element is not successful (decision block 1016) or the destination has been reached (decision block 1017), the VoIP network element routes the message with tracing information back on a path to the VoIP call originator (processing block 1018). Processing for the VoIP network trace functionality terminates at the End bubble shown in FIG. 11.

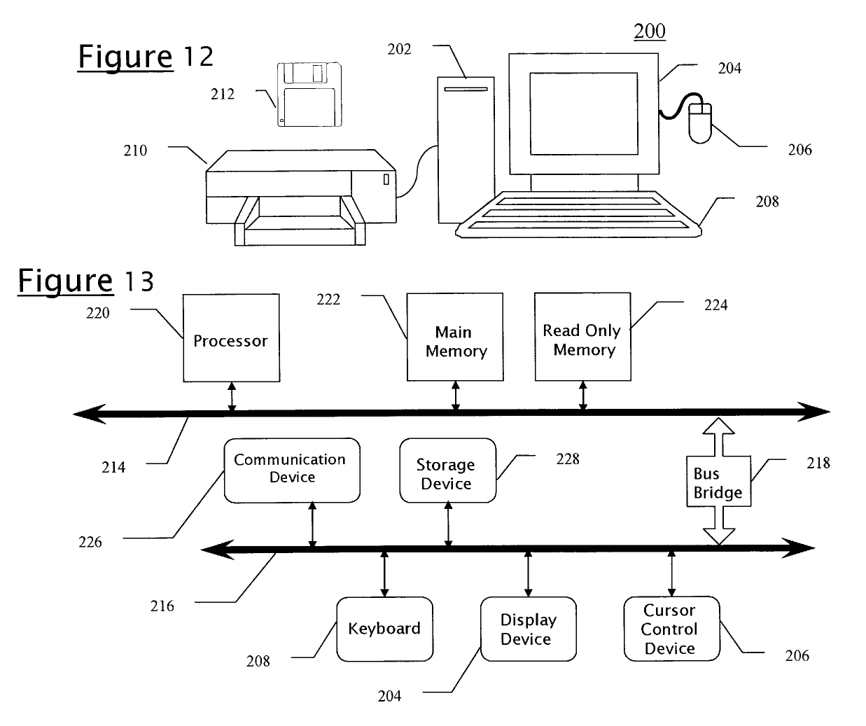

Having described above various embodiments of the network environment in which embodiments may operate, FIGS. 12 and 13 show an example of a computer system 200 illustrating an exemplary host, client 280, or server 250 computer system, in which the features of an example embodiment may be implemented. Computer system 200 is comprised of a bus or other communications means 214 and 216 for communicating information, and a processing means such as processor 220 coupled with bus 214 for processing information. Computer system 200 further comprises a random access memory (RAM) or other dynamic storage device 222 (commonly referred to as main memory), coupled to bus 214 for storing information and instructions to be executed by processor 220. Main memory 222 also may be used for storing temporary variables or other intermediate information during execution of instructions by processor 220. Computer system 200 also comprises a read only memory (ROM) and/or other static storage device 224 coupled to bus 214 for storing static information and instructions for processor 220.

An optional data storage device 228 such as a magnetic disk or optical disk and its corresponding drive may also be coupled to computer system 200 for storing information and instructions. Computer system 200 can also be coupled via bus 216 to a display device 204, such as a cathode ray tube (CRT) or a liquid crystal display (LCD), for displaying information to a computer user. For example, image, textual, video, or graphical depictions of information may be presented to the user on display device 204. Typically, an alphanumeric input device 208, including alphanumeric and other keys is coupled to bus 216 for communicating information and/or command selections to processor 220. Another type of user input device is cursor control device 206, such as a conventional mouse, trackball, or other type of cursor direction keys for communicating direction information and command selection to processor 220 and for controlling cursor movement on display 204.

Alternatively, the client 280 can be implemented as a network computer or thin client device. Client 280 may also be a laptop or palm-top computing device, such as the Palm Pilot™. Client 280 could also be implemented in a robust cellular telephone, where such devices are currently being used with Internet micro-browsers. Such a network computer or thin client device does not necessarily include all of the devices and features of the above-described exemplary computer system; however, the functionality of an example embodiment or a subset thereof may nevertheless be implemented with such devices.

A communication device 226 is also coupled to bus 216 for accessing remote computers or servers, such as web server 250, or other servers via the Internet, for example. The communication device 226 may include a modem, a network interface card, or other well-known interface devices, such as those used for interfacing with Ethernet, Token-ring, or other types of networks. In any event, in this manner, the computer system 200 may be coupled to a number of servers 250 via a conventional network infrastructure such as the infrastructure illustrated and described above.

The system of an example embodiment includes software, information processing hardware, and various processing steps, which are described above. The features and process steps of example embodiments may be embodied in machine or computer executable instructions. The instructions can be used to cause a general purpose or special purpose processor, which is programmed with the instructions to perform the steps of an example embodiment. Alternatively, the features or steps may be performed by specific hardware components that contain hard-wired logic for performing the steps, or by any combination of programmed computer components and custom hardware components. While embodiments are described with reference to the Internet, the method and apparatus described herein is equally applicable to other network infrastructures or other data communications systems.

Various embodiments are described. In particular, the use of embodiments with various types and formats of data structures may be described. It will be apparent to those of ordinary skill in the art that alternative embodiments of the implementations described herein can be employed and still fall within the scope of the claimed invention. In the detail herein, various embodiments are described as implemented in computer-implemented processing logic denoted sometimes herein as the “Software”. As described above, however, the claimed invention is not limited to a purely software implementation.

The software and/or data described herein may further be transmitted or received over a network 260 via the communication device 226 utilizing any one of a number of well-known transfer protocols, for example, the hyper text transfer protocol (HTTP). While the machine-readable medium 212 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the disclosed subject matter, or that is capable of storing, encoding, or carrying data structures utilized by or associated with such a set of instructions. The term “machine-readable medium” shall accordingly be taken to include, but not be limited to, solid-state memories, optical and magnetic media, and carrier wave signals.

Although the present specification describes components and functions implemented in the embodiments with reference to particular standards and protocols, the disclosed subject matter may be not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

Thus, as described above, a method and apparatus for call signaling and media tracing in a voice over IP (VoIP) network is disclosed. Although the disclosed subject matter has been described with reference to several example embodiments, it may be understood that the words that have been used are words of description and illustration, rather than words of limitation. Changes may be made within the purview of the appended claims, as presently stated and as amended, without departing from the scope and spirit of the disclosed subject matter in all its aspects. Although the disclosed subject matter has been described with reference to particular means, materials, and embodiments, the disclosed subject matter is not intended to be limited to the particulars disclosed; rather, the subject matter extends to all functionally equivalent structures, methods, and uses such as are within the scope of the appended claims.

We claim:

1. A method comprising:
receiving a VoIP signaling packet, the VoIP signaling packet including information indicative of a request for trace information;
appending trace information to the VoIP signaling packet; and
routing the VoIP signaling packet with the trace information to a next network element on a path to a destination node.

2. The method as claimed in claim 1 wherein the trace information includes an identifier of a network element.

3. The method as claimed in claim 1 wherein the trace information includes an identifier of each network element in the path that has already processed the VoIP signaling packet.

4. The method as claimed in claim 1 further including routing the VoIP signaling packet with the trace information to a previous network element on a path to a source node, if an error condition is encountered.

5. A method comprising:
activating a VoIP trace mode;
receiving a VoIP signaling packet;
appending trace information to the VoIP signaling packet, if the VoIP trace mode is activated; and
routing the VoIP signaling packet with the trace information to a next network element on a path to a destination node.

6. The method as claimed in claim 5 wherein the trace information includes an identifier of a network element.

7. The method as claimed in claim 5 wherein the trace information includes an identifier of each network element in the path that has already processed the VoIP signaling packet.

8. The method as claimed in claim 5 further including routing the VoIP signaling packet with the trace information to a previous network element on a path to a source node, if an error condition is encountered.

9. An apparatus comprising:
means for receiving a VoIP signaling packet, the VoIP signaling packet including information indicative of a request for trace information;
means for appending trace information to the VoIP signaling packet; and
means for routing the VoIP signaling packet with the trace information to a next network element on a path to a destination node.

10. An apparatus comprising:
means for activating a VoIP trace mode;
means for receiving a VoIP signaling packet;
means for appending trace information to the VoIP signaling packet, if the VoIP trace mode is activated; and
means for routing the VoIP signaling packet with the trace information to a next network element on a path to a destination node.

11. A VoIP call trace information generator comprising:
a message processor to receive a VoIP signaling packet, the VoIP signaling packet including information indicative of a request for trace information, to decode the information indicative of a request for trace information, and to append trace information to the VoIP signaling packet; and
a message transfer engine to route the VoIP signaling packet with the trace information to a next network element on a path to a destination node.

12. The VoIP call trace information generator as claimed in claim 11 wherein the trace information includes an identifier of a network element.

13. The VoIP call trace information generator as claimed in claim 11 wherein the trace information includes an identifier of each network element in the path that has already processed the VoIP signaling packet.

14. The VoIP call trace information generator as claimed in claim 11, the message transfer engine being further operable to route the VoIP signaling packet with the trace information to a previous network element on a path to a source node, if an error condition is encountered.

15. A system comprising:
a plurality of network elements on a path between a VoIP call originator and a VoIP call destination, each of the plurality of network elements including tracing functionality to receive a VoIP signaling packet, the VoIP signaling packet including information indicative of a request for trace information, to decode the information indicative of a request for trace information, to append trace information to the VoIP signaling packet; and to route the VoIP signaling packet with the trace information to a next network element on the path to the VoIP call destination.

16. The system as claimed in claim 15 wherein the trace information includes an identifier of a network element of the plurality of network elements.

17. The system as claimed in claim 15 wherein the trace information includes an identifier of each network element in the path that has already processed the VoIP signaling packet.

18. A method comprising:
receiving a VoIP signaling packet;
routing the VoIP signaling packet to a next network element on a path to a destination node;
appending error/trace information to the VoIP signaling packet, if an error condition is encountered; and
routing the VoIP signaling packet with the error/trace information to a previous network element on a path to a source node.

19. The method as claimed in claim 18 wherein the error/trace information includes an identifier of a network element.

20. The method as claimed in claim 18 wherein the error/trace information includes an error code.

21. A VoIP call trace information generator comprising:
a message processor to receive a VoIP media packet, the VoIP media packet including information indicative of a request for trace information, to decode the information indicative of a request for trace information, and to append trace information to the VoIP media packet; and
a message transfer engine to route the VoIP media packet with the trace information to a next network element on a path to a destination node.

22. The VoIP call trace information generator as claimed in claim 21 wherein the trace information includes an identifier of a network element.

23. The VoIP call trace information generator as claimed in claim 21 wherein the trace information includes an identifier of each network element in the path that has already processed the VoIP media packet.

24. The VoIP call trace information generator as claimed in claim 21, the message transfer engine being further operable to route the VoIP media packet with the trace information to a previous network element on a path to a source node.
